(19) United States
(12) Patent Application Publication
(10) Pub. No.: US 2015/0208726 A1
(43) Pub. Date: Jul. 30, 2015

(54) CONNECTING HEAD OF AN ELECTRONIC CIGARETTE AND ELECTRONIC CIGARETTE

(71) Applicant: KIMREE HI-TECH INC., Tortola (VG)

(72) Inventor: Qiuming Liu, Huizhou City (CN)

(21) Appl. No.: 14/412,433

(22) PCT Filed: Apr. 7, 2013
(86) PCT No.: PCT/CN2013/073829

§ 371 Date: Dec. 31, 2014

(51) Int. Cl. A24F 47/00; H05B 1/02

(52) U.S. Cl. CPC A24F 47/008; H05B 1/0244

(57) ABSTRACT

An electronic cigarette (100) and a connecting head (3) for an electronic cigarette are provided. The electronic cigarette (100) includes an inhalation rod (2), a battery rod (1), and a connecting head (3). The connecting head (3) of the electronic cigarette (100) makes the inhalation rod (2) and the battery rod (3) connected into an integral and formed a central airway in an internal thereof. The connecting head (3) includes an exposed step (31), a first connecting end (31) and a second connecting end (33) disposed at the two sides of the exposed step (31) respectively along a radial direction. The first connecting end (31) is used to connect with the battery rod (2) of the electronic cigarette (100), and the second connecting end (33) connects with the inhalation rod (2). A surface of the exposed step (31) disposes at least one air inlet (311). When assembling the electronic cigarette (100), the air inlet (311) is exposed on the surface of the electronic cigarette (100). When the air pressure inside the inhalation rod (2) is less than the outside air pressure, air is supplied into the internal of the inhalation rod (2) by the air inlet (311). The sensitivity of the air inlet (311) on the connecting head for sensing the ventilation volume is very high, then easy to control the ventilation volume, and then can effectively guarantee the stability of the electronic cigarette taste.

### FIELD OF THE INVENTION

The present invention relates to electronic cigarettes, especially relates to a connecting head of an electronic cigarette and electronic cigarettes.

### BACKGROUND OF THE INVENTION

Conventional electronic cigarette includes an inhalation rod and a battery rod. In the inhalation rod disposes a liquid-storage cotton operable to store e-liquid and an atomizer operable to vaporize the e-liquid to aerosol. In the battery rod disposes a battery operable to supply power to the atomizer for working.

Many components of the conventional electronic cigarette dispose air vent therein. Because of requiring these multiple air vents to co-adjust the ventilation volume simultaneously, the ventilation volume is not easy for control and then leading to the aerosol volume not easy for control. The sensitivity is very low, thus affecting the stability of the electronic cigarette taste.

### SUMMARY OF THE INVENTION

An objective of the present invention is to provide a connecting head for electronic cigarettes. The inductive sensitivity of air inlets on the connecting head to the ventilation volume is very high, then the ventilation volume is easy to control, further to effectively guarantee the stability of the electronic cigarette taste.

To achieve the aforementioned objective, the present invention provides a connecting head of electronic cigarette. The connecting head is removably connected between a battery rod and an inhalation rod; the connecting head disposes at least on air inlet, the air inlet is exposed on the surface of the electronic cigarette, configured for ambient air entering into an internal central airway of the electronic cigarette; by adjusting the position of the connecting head relative to the battery rod or the inhalation rod, it is achieved to adjust the size of the air inlet to adjust the ventilation volume enters into internal central airway of the electronic cigarette through the air inlet.

Furthermore, the connecting head includes an exposed step, a first connecting end and a second connecting end. The exposed step is exposed on the surface of the electronic cigarette. The first connecting end and the second connecting end are disposed along the length direction of the exposed step and locate at the two sides of the exposed step respectively. The air inlet is disposed on the surface of the exposed step and communicates with the internal central airway of the electronic cigarette. And the first connecting end removably connects with the battery rod, and the second connecting end removably connects with the inhalation rod, making the position of the connecting head relative to the battery rod or the inhalation rod adjustable.

Furthermore, the first connecting end, the exposed step and the second connecting end of the connecting head are hollow tubular structure and individually serve as one part of the internal central airway of the electronic cigarette The air inlet penetrates from an outer surface of the exposed step to an inner surface of the exposed step to communicate with the internal central airway of the electronic cigarette. By adjusting the position of the connecting head relative to the battery rod or the inhalation rod to partially block the air inlet, then to adjust the size of the air inlet.

Furthermore, the connecting head is a threaded connecting head or a magnetic connecting head.

Furthermore, the number of the air inlet is two or more, and the two or more air inlets are uniformly disposed along the circumferential direction of the exposed step.

The connecting head of the electronic cigarette of the present invention: the connecting head makes the inhalation rod and the battery rod being connected into an integral. On the exposed step of the connecting head disposes at least one air inlet, it is only needed to control the ventilation volume of the at least one air inlet. The sensitivity of the air inlet on the connecting head for sensing the ventilation volume is very high, then easy to control the ventilation volume, and then can effectively guarantee the stability of the electronic cigarette taste.

An further objective of the present invention also is to provide an electronic cigarette, in which the sensitivity of the air inlet on the connecting head of the electronic cigarette for sensing the ventilation volume is very high, then easy to control the ventilation volume, and then can effectively guarantee the stability of the electronic cigarette taste.

To achieve the aforementioned objective, the present invention also provides an electronic cigarette, including an inhalation rod and an battery rod. Wherein, the electronic cigarette further includes a connecting head; the inhalation rod and the battery rod are connected into an integral by the connecting head and forms an internal central airway of the electronic cigarette; the connecting head is removably connected between the battery rod and the inhalation rod; one the connecting head disposes at least on air inlet, the air inlet is exposed on the surface of the electronic cigarette, serving for ambient air entering into the internal central airway of the electronic cigarette; by adjusting the position of the connecting head relative to the battery rod or the inhalation rod, it is achieved to adjust the size of the air inlet to adjust the ventilation volume enters into the internal central airway of the electronic cigarette through the air inlet.

The connecting head includes an exposed step, a first connecting end and a second connecting end. The exposed step is exposed on the surface of the electronic cigarette. The first connecting end and the second connecting end are disposed along the length direction of the exposed step and located at the two sides of the exposed step respectively. The air inlet is disposed on the surface of the exposed step and communicates with the internal central airway of the electronic cigarette. And the first connecting end removably connects with the battery rod, and the second connecting end removably connects with the inhalation rod, making the position of the connecting head relative to the battery rod or the inhalation rod adjustable.

The first connecting end, the exposed step and the second connecting end of the connecting head are hollow tubular structure and individually serve as one part of the internal central airway of the electronic cigarette. The air inlet penetrates from the outer surface of the exposed step to the inner surface of the exposed step to communicate with the internal central airway of the electronic cigarette. By adjusting the position of the connecting head relative to the battery rod or the inhalation rod to partially block the air inlet, then to adjust the size of the air inlet.

Furthermore, the connecting head is a threaded connecting head or a magnetic connecting head.

Furthermore, the number of the air inlet is two or more, and the two or more air inlets are uniformly disposed along the circumferential direction of the exposed step.

Furthermore, the battery rod includes a battery sleeve, a light cap, a pneumatic switch, a switch seat, an inhalation rod linking seat, an insulation ring, a first electrode and a second electrode. The battery sleeve, the inhalation rod linking seat and the insulation ring are hollow tubular structure. The light cap covers disposed at one end of the battery sleeve. In the light cap disposes a LED. The switch seat is disposed in the inner wall of one end of the battery sleeve near the light cap. The inhalation rod linking seat is disposed in the inner wall of one end of the battery sleeve away from the light cap. The pneumatic switch is disposed on the switch seat. The first electrode is inserted in the inhalation rod linking seat. The body of the inhalation rod linking seat serves as a second electrode. The first electrode and the second electrode are isolated by the insulation ring. The pneumatic switch controls the turn-on and turn-off of the first electrode and the second electrode. Between the switch seat and the inhalation rod linking seat defines an accommodating chamber for assembling the battery. The inhalation rod linking seat connects with the first connecting end of the connecting head.

Furthermore, the inhalation rod includes an atomizer and a cartridge. The atomizer includes an atomization seat, a heating wire assembly, a fiberglass tube and a liquid-storage cotton. The cartridge includes a cartridge shell, a sealing ring and a mouthpiece cover. The heating wire assembly includes a first electrode, a heating element and a second electrode which are in turn connected. The atomization seat, the fiberglass, the liquid-storage cotton, the cartridge shell, the sealing ring and the mouthpiece are hollow tubular structure. On the surface of the fiberglass defines an accommodation cutout. The heating element is disposed on the accommodation cutout. The fiberglass is accommodated in the liquid-storage cotton and abuts with the liquid-storage cotton. The liquid-storage cotton is accommodated in the cartridge shell. The sealing ring is disposed on the inner wall of one end of the cartridge shell. The mouthpiece cover is disposed at one end of the cartridge shell away from the liquid-storage cotton and is connected to the sealing ring. The air vent of the mouthpiece cover communicates with the air path formed by the atomization seat, the fiberglass tube, the liquid-storage cotton, the cartridge shell and the sealing ring. And, one connecting end of the atomization seat abuts to the fiberglass tube and the liquid-storage cotton, and forms sealing structure with the cartridge shell. The other connecting end of the atomization seat connects with the second connecting end of the connecting head. The first electrode and the second electrode of the heating wire assembly connect to the first electrode and the second electrode of the battery rod respectively.

Furthermore, the connecting end of the inhalation rod linking seat disposes an inner thread, the first connecting end of the connecting head disposes an outer thread, the connecting end of the inhalation rod linking seat and the first connecting end of the connecting head are engaged with other by thread.

Furthermore, the second connecting end of the connecting head disposes an inner thread, the connecting end of the atomization seat disposes an outer thread, the second connecting end of the connecting head and the connecting end of the atomization seat are engaged with other by thread.

Furthermore, the first connecting end and the second connecting end of the connecting head dispose an accommodation chamber respectively. In the accommodation chambers are fixed with permanent magnets. The connecting end of the inhalation rod linking seat and the connecting end of the atomization seat individually includes a linking piece made of iron material. The first connecting end of the connecting head and the linking piece of the inhalation rod linking seat are connected by the magnetic force of the permanent magnet. The second connecting end of the connecting head and the linking piece of the atomization sea are connected by the magnetic force of the permanent magnet.

Furthermore, the heating element is a resistor.

Furthermore, the atomizer is a disposable atomizer.

Furthermore, the LED is a red LED.

Furthermore, the connecting head and the inhalation rod are integrally formed.

Furthermore, the connecting head and the battery rod are integrally formed.

The electronic cigarette of the present invention: the inhalation rod and the battery rod are connected into an integral by a connecting head. On the exposed step of the connecting head disposes at least one air inlet, it is only needed to control the ventilation volume of the at least one air inlet. The sensitivity of the air inlet on the connecting head for sensing the ventilation volume is very high, then easy to control the ventilation volume, and then can effectively guarantee the stability of the electronic cigarette taste.

The embodiment of the present invention will be described in detail in the following drawings.

### BRIEF DESCRIPTION OF THE DRAWINGS

FIG. 1 is a main view of an electronic cigarette according to a first embodiment of the present invention.

FIG. 2 is a main view of an inhalation rod of the electronic cigarette according to the first embodiment of the present invention.

FIG. 3 is an exploded view of the inhalation rod of the electronic cigarette according to the first embodiment of the present invention.

FIG. 4 is an enlarged sectional view along line A-A of the inhalation rod shown in FIG. 2.

FIG. 5 is a sectional view of the battery rod of the electronic cigarette according to the first embodiment of the present invention.

### DETAILED DESCRIPTION OF THE INVENTION

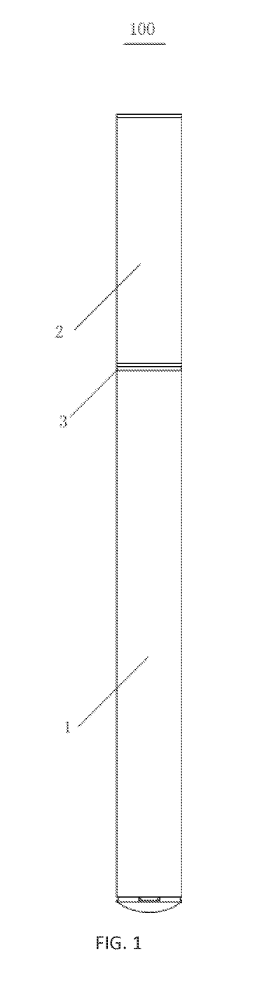

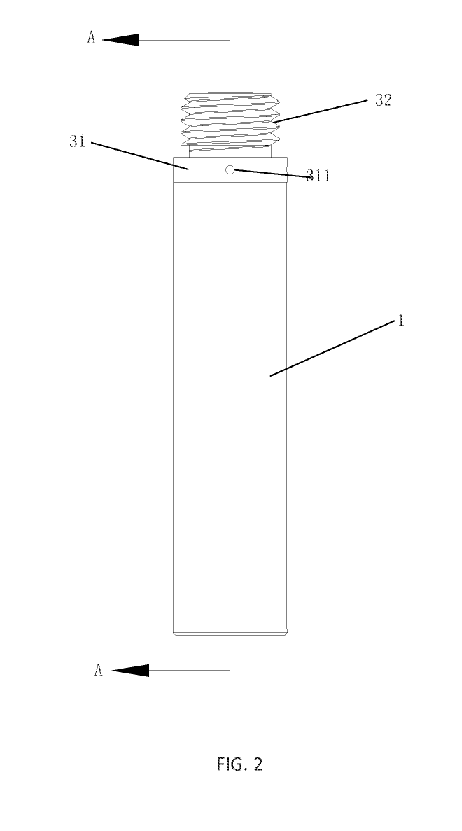

Referring to FIG. 1 to FIG. 5, a first embodiment of the present invention provides an electronic cigarette. The electronic cigarette 100 includes a battery rod 1 and an inhalation rod 2. The electronic cigarette 100 also includes a connecting head 3. The inhalation rod 2 and one end of the connecting head 3 are removably connected, and the battery rod 1 and the other end of the connecting head 3 are removably connected. The inhalation rod 2 and the battery rod 1 are connected into integration by the connecting head 3, wherein the internal of the inhalation rod 2, the connecting head 3 and the battery rod 1 forms internal central airway of the electronic cigarette.

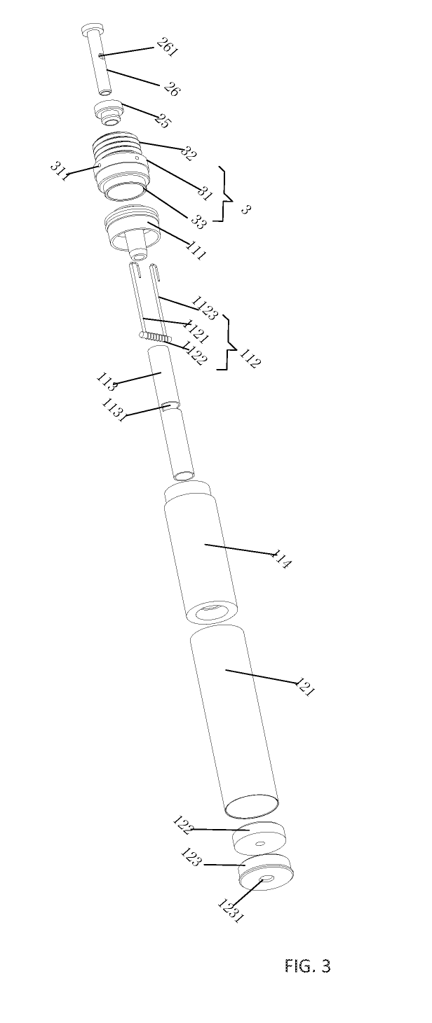

Specifically, referring to FIG. 3, the connecting head 3 includes an exposed step 31, a first connecting end 32 and a second connecting head 33 which are all hollow tubular structure. The first connecting end 32 removably connects with the battery rod 1. The second connecting end 33 removably connects with the inhalation rod 2, making position of the connecting head 3 relative to the battery rod 1 or the inhalation rod 2 be adjustable. The internal hollow structure of the first connecting end 32, the exposed step 31 and the second connecting 33 is one part of the internal central airway of the electric cigarette. Furthermore, the first connecting end 32 and the second connecting end 33 are disposed along the length direction of the exposed step 31 and located at the two sides of the exposed step 31 respectively. Wherein, the surface of the exposed step 31 defines at least one air inlet 311. The exposed step 31 is exposed on the surface of the electronic cigarette 100, that is to say, the air inlet 311 is exposed on the surface of the electronic cigarette 100. The air inlet 311 passes through from an outer surface of the exposed step 31 to an inner surface of the exposed step 31 to communicate with internal central airway of the electronic cigarette. When smoking by the inhalation rod 2, and when the air pressure inside the inhalation rod 2 is less than the outside air pressure, air is supplied into the internal of the inhalation rod 2 by the air inlet 311. By adjusting the position of the connecting head 3 relative to the battery rod 1 or the inhalation rod 2, adjusts the size of the air inlet 311 to adjust the ventilation volume entering into the internal central airway of the electronic cigarette through the air inlet 311. Specifically, by adjusting the position of the connecting head 3 relative to the battery rod 1 or the inhalation rod 2 to partially block the air inlet 311 adjusts the size of the air inlet 311, and then control the ventilation volume.

For example, the second connecting end 33 of the connecting head 3 disposes an inner thread, and one end of the inhalation rod 2 connecting with the connecting head 3 disposes an outer thread. By screwing the inhalation rod 2 into the connecting head 3 may achieve partial blocking on the air inlet 311, and by screwing the inhalation rod 2 out from the connecting head 3 may achieve releasing the partially blocked air inlet, then may achieve the adjustment of the ventilation volume entering into the internal central airway of the electronic cigarette through the air inlet 311. Certainly, it is also to correspondingly dispose the number and size of the air inlet 311 according to the actual needs, thus to finally control the ventilation volume entering into the central airway of the electronic cigarette.

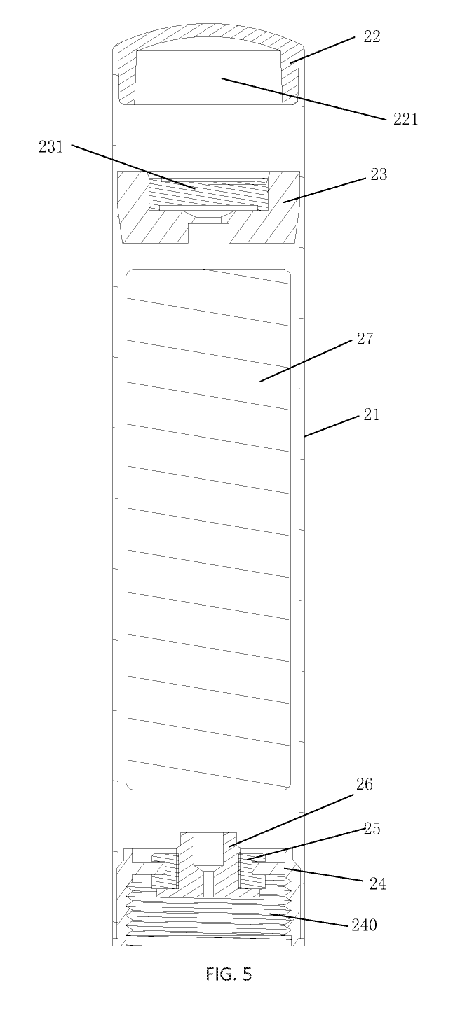

In a specific embodiment, referring to FIG. 3 and FIG. 5, the battery rod 1 includes a battery sleeve 21, a light cap 22, a pneumatic switch 231, a switch seat 23, an inhalation rod linking seat 240, an insulation ring 25, a first electrode 26 (designated as negative electrode) and a second electrode 24 (designated as positive electrode). The battery sleeve 21, the inhalation rod linking seat 240 and the insulation ring 25 are hollow tubular structure.

Wherein, the light cap 22 covers at one end of the battery sleeve 21. The light cap 22 disposes an LED 221 therein. The LED 221 is usually a red LED, and the number of the LED 221 is one or other number arranged according to needs. The light cap 22 disposes an air inlet (not shown) thereon, and the air inlet further communicates into an air path formed by the internal of the inhalation rod 2, the connecting head 3 and the battery rod 1.

The switch seat 23 is disposed in the inner wall of one end of the battery sleeve 21 near the light cap 22. The inhalation rod linking seat 240 is disposed in the inner wall of one end of the battery sleeve 21 away from the light cap 22. The pneumatic switch 231 is disposed on the switch seat 23. The first electrode 26 is inserted in the inhalation rod linking seat 240. The body of the inhalation rod linking seat 240 serves as the second electrode 24. The first electrode 26 and the second electrode 24 are isolated by the insulation ring 25.

Wherein, referring to FIG. 3 and FIG. 5, the first electrode 26 is substantially screw structure, including a cap body and a rod body. The rod body is inserted in the inhalation rod linking seat 240. By clamping the cap body in the inhalation rod linking seat 240, the positioning and fixing are more convenient. Between the switch seat 23 and the inhalation rod linking seat 240 defines an accommodating chamber for assembling a battery 27. The pneumatic switch 231 controls the turn-on and turn-off of the first electrode 26 and the second electrode 24. The inhalation rod linking seat 240 is configured for connecting with the first connecting end 32 of the connecting head 3.

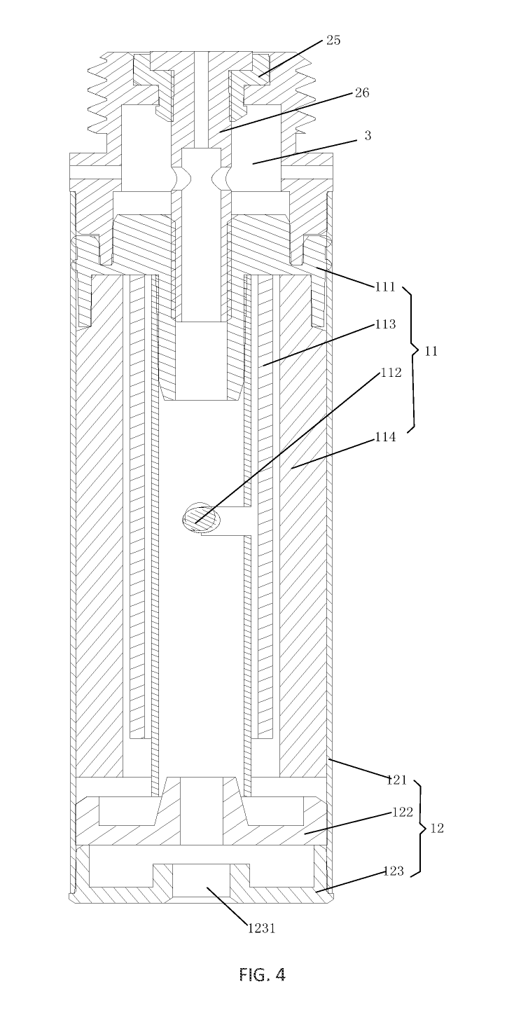

Referring to FIG. 4, the inhalation rod 2 includes an atomizer 11 and a cartridge 12. The atomizer 11 includes an atomization seat 111, a heating wire assembly 112, a fiberglass tube 113 and a liquid-storage cotton 114. Wherein, the liquid-storage cotton 114 stores e-liquid. The cartridge 12 includes a cartridge shell 121, a sealing ring 122 and a mouthpiece cover 123. The heating wire assembly 112 includes a first electrode 1121, a heating element 1122 and a second electrode 1123 which are in turn connected. Wherein, the first electrode 26 extends into the atomization seat 111 and is supported at a bottom inner wall of the fiberglass tube 113. And an internal of the first electrode 26 is hollow, serving as one part of the internal central airway of the electronic cigarette. Meanwhile, the first electrode 26 disposes a through hole 261 along the radial direction. The through hole 261 is communicated with the internal central airway of the electronic cigarette, and may be used to adjust the airflow pressure in the internal central airway of the electronic cigarette.

The atomization seat 111, the fiberglass 113, the liquid-storage cotton 114, the cartridge shell 121, the sealing ring 122 and the mouthpiece 123 are hollow tubular structure. On the surface of the fiberglass 113 defines an accommodation cutout 1131. The heating element 1122 is disposed on the accommodation cutout 1131. The fiberglass 113 is accommodated in the liquid-storage cotton 114 and abuts with the liquid-storage cotton 114. The liquid-storage cotton 114 is accommodated in the cartridge shell 121. The sealing ring 122 is disposed on the inner wall of one end of the cartridge shell 121. The mouthpiece cover 123 is disposed at one end of the cartridge shell 121 away from the liquid-storage cotton 114 and is connected to the sealing ring 122. An air vent 1231 of the mouthpiece cover 123 communicates with an air path formed by the atomization seat 111, the fiberglass tube 113, the liquid-storage cotton 114, the cartridge shell 121 and the sealing ring 122. And, one connecting end of the atomization seat 111 abuts to the fiberglass tube 113 and the liquid-storage cotton 114, and forms sealing structure with the cartridge shell 121. The other connecting end of the atomization seat 111 connects with the second connecting end 33 of the connecting head 3. The first electrode 1121 and the second electrode 1123 of the heating wire assembly 112 connect to the first electrode 26 and the second electrode 24 of the battery rod 1 respectively.

Referring FIG. 3 to FIG. 5, the working principle of the electronic cigarette 100 is briefly described as following.

A liquid-guiding body (not shown) in the atomizer 11 contacts the liquid-storage cotton 114. When users smoking, air enters through the air inlet 311 on the exposed step 31 of the connecting head 3, the air pressure in the internal central airway of the electronic cigarette is less than the external ambient air pressure, some air will enter into the air inlet on the light cap 22 to compensate for the pressure difference in a certain extent. The air entered into the internal of the air path through the air inlet on the light cap 22 triggers the pneumatic switch 231; after the pneumatic switch 231 is triggered, the circuit loop composed of the pneumatic switch 231, the battery 27, the first electrode 26, the second electrode 24 and the heating element 1122 is conducted. The heating element 1122 heats and vaporizes the e-liquid stored in the liquid guiding body to aerosol. The aerosol enters into the internal central airway of the electronic cigarette, and finally inhaled into mouth by users through the air vent 1231 of the mouthpiece cover 123. When users stopping smoking, after mouth of users leaving the mouthpiece cover 123 a certain position, air enters into the air path formed by the inhalation rod 2, the connecting head 3 and the internal of the battery rod 1 mainly through the air inlet 311 on the connecting head 3, achieving the balance of the internal air pressure and the external air pressure of the air path, that is to say, the air pressure is equal. At this time, the pneumatic switch 231 turns off, and the heating wire assembly 112 stops working, and no aerosol produced.

In the aforementioned embodiment, because the main air inlet 311 is disposed at the exposed step 31 on the connecting head 3, no need to cooperate with the air inlet 311 at other positions (such as on the first electrode) and only needs to adjust the air inlet 311 disposed at the exposed step 31 on the connecting head 3. Specifically, by adjusting the position of the connecting head 3 and the battery rod 1 or the inhalation rod 2 to partially block the air inlet 311 to adjust the size of the air inlet 311, then further adjust the ventilation volume enters into the internal central airway of the electronic cigarette through the air inlet 311. Therefore the adjustment is simple and convenient. Because when using this design, the ventilation volume entering into the internal central airway of the electronic cigarette is almost only affected by the air inlet 311, the sensitivity is very high, and it is easy to control the ventilation volume and thus achieve the accuracy of the ventilation volume control. After finishing the adjustment, the ventilation volume is constant, and then can effectively guarantee the taste stability of the electronic cigarette 100. In addition, the electronic cigarette 100 using the connecting head 3 of the structure described in any aforementioned embodiment, it is only required to adjust the ventilation volume of the air vent 311 at a known position, helping to reduce the noise generated by smoking.

In a specific applicable embodiment, the heating element 1122 is usually a resistor, preferably is a resistance wire.

In a specific applicable embodiment, continue referring to FIG. 3, the connecting head 3 is a thread connecting head 3. Specifically, the connecting end of the inhalation rod linking seat 240 disposes an inner thread, and the first connecting end 32 of the connecting head 3 disposes an outer thread. The connecting end of the inhalation rod linking seat 240 and the first connecting end 32 of the connecting head 3 are engaged with each other by thread. While the second connecting end 33 of the connecting head 3 disposes an inner thread, and the connecting end of the atomization seat 111 disposes an outer thread. The second connecting end 33 of the connecting head 3 and the connecting end of the atomization seat 111 are engaged with each other by thread.

Certainly, the connecting end of the inhalation rod linking seat 240 may be disposed with outer thread, the first connecting end 32 of the connecting head 3 disposes inner thread, the connecting end of the inhalation rod linking seat 240 and the first connecting end 32 of the connecting head 3 are engaged with each other by thread. While the second connecting end 33 of the connecting head 3 may be disposed with inner thread, the connecting end of the atomization seat 111 disposes inner thread, the second connecting end 33 of the connecting head 3 and the connecting end of the atomization seat 111 are engaged with each other by thread.

In other alternative embodiments, the connecting head 3 is a magnetic connecting head 3. Specifically, the first connecting end 32 and the second connecting end 33 of the connecting head 3 dispose an accommodation chamber respectively. In the accommodation chambers are fixed with permanent magnets. The connecting end of the inhalation rod linking seat 240 and the connecting end of the atomization seat 111 individually includes a linking piece made of iron material. The first connecting end 32 of the connecting head 3 and the linking piece of the inhalation rod linking seat 240 are connected by magnetic force of the permanent magnet. The second connecting end 33 of the connecting head 3 and the linking piece of the atomization seat 111 are connected by magnetic force of the permanent magnet. Certainly, the inhalation rod linking seat 240 and the connecting end of the atomization seat 111 may also individually dispose an accommodation chamber, and the permanent magnets are disposed in the accommodation chamber; and at the same time the first connecting end 32 and the second connecting end 33 of the connecting head 3 are disposed as the linking piece which is made of materials including iron, then it is also achieved connections between the first connecting end 32, the second connecting end 33 of the connecting head 3 and the inhalation rod linking seat 240, the atomization seat 111 by the magnetic force of the permanent magnet respectively. Wherein using magnetic to connect, the disassembly is easy and convenient.

Certainly, here it is not limited that the type of the connecting head 3 can only be the thread connecting head 3 or the magnetic connecting head 3, and the type of the connecting head 3 may also be in other types. Not going to repeat them here.

In the aforementioned embodiment, the number of the air inlet 311 also may be two or more. The two or more air inlets 311 are uniformly disposed along the circumferential direction of the exposed step 31 of the connecting head 3. Certainly, when adjusting the ventilation volume and the taste of the electronic cigarette 100, it is required to consider the number and the area of the air inlets 311. Here not going to specifically describe the adjusting principle and procedure, because the air inlet 311 is serving as the main air inlet 311, it is to adjust the air inlet 311 only which is simple and convenient, and the sensitivity is very high. After the adjustment is finished, the ventilation volume is stable, and then the taste of the electronic cigarette 100 is very stable.

In a specific applicable embodiment, the atomizer 11 is a disposable atomizer to be replaced after finishing the e-liquid in the liquid-storage cotton 114, helping to keep the taste of the electronic cigarette 100.

In a specific applicable embodiment, the connecting head 3 using the structure described in any aforementioned embodiment may be integrally formed with the inhalation rod 2, and the assembly is convenient. Certainly, the connecting head 3 using the structure described in any aforementioned embodiment may be integrally formed with the battery rod 1. When replacing the atomizer 11, it is not necessary to replace the connecting head 3, and the assembly is convenient, helping to save cost.

The present invention also provides a connecting head of the electronic cigarette. The connecting head is a connecting head of the structure described in any the aforementioned embodiment.

The present invention also provides an atomizer of the electronic cigarette. The atomization seat of the atomizer is integrally formed with the connecting head of the structure described in any the aforementioned embodiment.

In the aforementioned embodiment, because the main air inlet 311 is disposed at the exposed step 31 on the connecting head 3 and exposed on the surface of the electronic cigarette 100, and the air inlet 311 is directly communicated with the internal central airway of the electronic cigarette; also because the connecting head 3 removably connects between the battery rod 1 and the inhalation rod 2, the connecting head 3 can relatively rotate to adjust the size of the air inlet 311. So for the air inlet 311 disposed on the connecting head 3, the adjustment is simple and convenient. Because when using this design, the ventilation volume entering into the internal central airway of the electronic cigarette is almost only affected by the air inlet 311, and the sensitivity for the ventilation volume is very high, and it is easy to control the ventilation volume and then can accurately control of the ventilation volume. After finishing the adjustment, the ventilation volume is constant, and then can effectively guarantee the taste stability of the electronic cigarette 100. In addition, the electronic cigarette 100 using the connecting head of the structure described in any aforementioned embodiment, it is only required to adjust the ventilation volume of the air vent at a known position, helping to reduce the noise generated by smoking.

Embodiments of the present invention is shown and described in the above-mentioned. Various improvement and modifications can be made to the embodiments by those skilled in the art without departing from the true spirit and scope of the disclosure. The scope of the present invention is defined by the appended claims and equivalents thereof.

What is claimed is:

1. An connecting head wherein the connecting head is removably connected between a battery rod and an inhalation rod; the connecting head disposes at least on air inlet, the air inlet is exposed on an surface of the electronic cigarette, configured for ambient air entering into an internal central airway of the electronic cigarette; by adjusting the position of the connecting head relative to the battery rod or the inhalation rod adjusts the size of the air inlet to adjust the ventilation volume enters into the internal central airway of the electronic cigarette through the air inlet.

2. According to the connecting head in claim 1, wherein the connecting head includes an exposed step, a first connecting end and a second connecting end; the exposed step is exposed on the surface of the electronic cigarette; the first connecting end and the second connecting end are disposed along the length direction of the exposed step and located at the two sides of the exposed step respectively; the air inlet is disposed on the surface of the exposed step and communicates with internal central airway of the electronic cigarette; and the first connecting end removably connects with the battery rod, and the second connecting end removably connects with the inhalation rod, making the position of the connecting head relative to the battery rod or the inhalation rod adjustable.

3. According to the connecting head in claim 2, wherein the first connecting end, the exposed step and the second connecting end of the connecting head are hollow tubular structure and individually serve as one part of the internal central airway of the electronic cigarette; the air inlet penetrates from an outer surface of the exposed step to an inner surface of the exposed step to communicate with the internal central airway of the electronic cigarette; by adjusting the position of the connecting head relative to the battery rod or the inhalation rod to partially block the air inlet, then to adjust the size of the air inlet.

4. According to the connecting head in claim 1, wherein the connecting head is a threaded connecting head or a magnetic connecting head.

5. According to the connecting head in claim 1, wherein the number of the air inlet is two or more, and the two or more air inlets are uniformly disposed along the circumferential direction of the exposed step.

6. An electronic cigarette, comprising an inhalation rod and a battery rod, wherein the electronic cigarette further includes a connecting head; the inhalation rod and the battery rod are connected into an integral by the connecting head and forms an internal central airway of the electronic cigarette; the connecting head is removably connected between the battery rod and the inhalation rod; one the connecting head disposes at least on air inlet, the air inlet is exposed on the surface of the electronic cigarette, serving for ambient air entering into the internal central airway of the electronic cigarette; by adjusting the position of the connecting head relative to the battery rod or the inhalation rod adjusts the size of the air inlet to adjust the ventilation volume enters into the internal central airway of the electronic cigarette through the air inlet.

7. According to the electronic cigarette in claim 6, wherein the connecting head includes an exposed step, a first connecting end and a second connecting end; the exposed step is exposed on the surface of the electronic cigarette; the first connecting end and the second connecting end are disposed along the length direction of the exposed step and located at the two sides of the exposed step respectively; the air inlet is disposed on the surface of the exposed step and communicates with the internal central airway of the electronic cigarette; and the first connecting end removably connects with the battery rod, and the second connecting end removably connects with the inhalation rod, making the position of the connecting head relative to the battery rod or the inhalation rod adjustable.

8. According to the electronic cigarette in claim 7, wherein the first connecting end, the exposed step and the second connecting end of the connecting head are hollow tubular structure and individually serve as one part of the internal central airway of the electronic cigarette; the air inlet penetrates from an outer surface of the exposed step to an inner surface of the exposed step to communicate with the internal central airway of the electronic cigarette; by adjusting the position of the connecting head relative to the battery rod or the inhalation rod to partially block the air inlet, then to adjust the size of the air inlet.

9. According to the electronic cigarette in claim 6, wherein the connecting head is a threaded connecting head or a magnetic connecting head.

10. According to the electronic cigarette in claim 6, wherein the number of the air inlet is two or more, and the two or more air inlets are uniformly disposed along the circumferential direction of the exposed step.

11. According to the electronic cigarette in claim 6, wherein the battery rod includes a battery sleeve, a light cap, a pneumatic switch, a switch seat, an inhalation rod linking seat, an insulation ring, a first electrode and a second electrode; the battery sleeve, the inhalation rod linking seat and the insulation ring are hollow tubular structure; the light cap covers at one end of the battery sleeve; the light cap disposes a LED therein; the switch seat is disposed in the inner wall of one end of the battery sleeve near the light cap; the inhalation rod linking seat is disposed in the inner wall of one end of the battery sleeve away from the light cap; the pneumatic switch is disposed on the switch seat; the first electrode is inserted in the inhalation rod linking seat; the body of the inhalation rod linking seat serves as a second electrode; the first electrode and the second electrode are isolated by the insulation ring; the pneumatic switch controls the turn-on and turn-off of the first electrode and the second electrode; between the switch seat and the inhalation rod linking seat defines an accommodating chamber for assembling the battery; the inhalation rod linking seat connects with the first connecting end of the connecting head.

12. According to the electronic cigarette in claim 11, wherein the inhalation rod includes an atomizer and a cartridge; the atomizer includes an atomization seat, a heating wire assembly, a fiberglass tube and a liquid-storage cotton; the cartridge includes a cartridge shell, a sealing ring and a mouthpiece cover; the heating wire assembly includes a first electrode, a heating element and a second electrode which are in turn connected; the atomization seat, the fiberglass, the liquid-storage cotton, the cartridge shell, the sealing ring and the mouthpiece are hollow tubular structure; on the surface of the fiberglass defines an accommodation cutout; the heating element is disposed on the accommodation cutout; the fiberglass is accommodated in the liquid-storage cotton and abuts with the liquid-storage cotton; the liquid-storage cotton is accommodated in the cartridge shell; the sealing ring is disposed on the inner wall of one end of the cartridge shell; the mouthpiece cover is disposed at one end of the cartridge shell away from the liquid-storage cotton and is connected to the sealing ring; the air vent of the mouthpiece cover communicates with the air path formed by the atomization seat, the fiberglass tube, the liquid-storage cotton, the cartridge shell and the sealing ring; and, one connecting end of the atomization seat abuts to the fiberglass tube and the liquid-storage cotton, and forms sealing structure with the cartridge shell; the other connecting end of the atomization seat connects with the second connecting end of the connecting head; the first electrode and the second electrode of the heating wire assembly connect to the first electrode and the second electrode of the battery rod respectively.

13. According to the electronic cigarette in claim 12, wherein the connecting end of the inhalation rod linking seat disposes an inner thread, the first connecting end of the connecting head disposes an outer thread, the connecting end of the inhalation rod linking seat and the first connecting end of the connecting head are engaged with other by thread.

14. According to the electronic cigarette in claim 13, wherein the second connecting end of the connecting head disposes an inner thread, the connecting end of the atomization seat disposes an outer thread, the second connecting end of the connecting head and the connecting end of the atomization seat are engaged with other by thread.

15. According to the electronic cigarette in claim 12, wherein the first connecting end and the second connecting end of the connecting head dispose an accommodation chamber respectively; in the accommodation chambers are fixed with permanent magnets; the connecting end of the inhalation rod linking seat and the connecting end of the atomization seat individually includes a linking piece made of iron material; the first connecting end of the connecting head and the linking piece of the inhalation rod linking seat are connected by the magnetic force of the permanent magnet; the second connecting end of the connecting head and the linking piece of the atomization sea are connected by the magnetic force of the permanent magnet.

16. According to the electronic cigarette in claim 12, wherein the heating element is a resistor.

17. According to the electronic cigarette in claim 12, wherein the atomizer is a disposable atomizer.

18. According to the electronic cigarette in claim 11, wherein the LED is a red LED.

19. According to the electronic cigarette in claim 6, wherein the connecting head and the inhalation rod are integrally formed

20. According to the electronic cigarette in claim 6, wherein the connecting head and the battery rod are integrally formed.
